(19) United States
(12) Patent Application Publication
(10) Pub. No.: US 2009/0058751 A1
(43) Pub. Date: Mar. 5, 2009

(54) PLATFORM NOISE MITIGATION METHOD USING BALANCED ANTENNA

(76) Inventors: SEONG-YOUP SUH, San Jose, CA (US); KWAN-HO LEE, Sunnyvale, CA (US); ANAND S. KONANUR, Sunnyvale, CA (US)

Correspondence Address: CARRIE A. BOONE, P.C., 2450 Louisiana, Suite # 400-711, HOUSTON, TX, 77006, US

(21) Appl. No.: 11/845,785

(22) Filed: Aug. 28, 2007

(51) Int. Cl. H01Q 9/16; H01Q 1/50

(52) U.S. Cl. 343/795; 343/821

(57) ABSTRACT

A balanced antenna is integrated into a wireless mobile device, such as a laptop computer, for improved antenna reception. The antenna is connected to a radio frequency (RF) interconnection cable. A balun is disposed between the antenna and the cable. By using a balanced antenna, the fraction of the noise produced by the motherboard and display of the wireless mobile device that is captured by the antenna is significantly reduced compared to that captured by an unbalanced antenna, and thus not captured by the antenna.

### TECHNICAL FIELD

This application relates to antennas and, more particularly, to antenna operation in wireless mobile devices.

### BACKGROUND

The performance of wireless communication is highly dependent on the platform noise level of the communicating devices. Both the system board and display are known sources of platform noise in mobile devices. The range and throughput of the devices are largely determined by the signal-to-noise ratio (SNR), no matter what modulation scheme is used. An antenna connected to the wireless mobile device picks up noise from the device platform, adversely affecting the wireless communication by the device. Clock signals, a source of electromagnetic interference (EMI), may be received by the antenna, as may other signals transmitted within the device.

A conventional antenna system uses an unbalanced antenna with large ground plane, as depicted in FIG. 1. The ground plane is a part of a radiating element, which collects the platform noise extensively. The conventional unbalanced antenna radiation/reception occurs from not only the antenna/ground plane element but also from a radio frequency (RF) interconnection cable, which is usually embedded inside the wireless mobile platform, due to the unbalanced feeding of the antenna.

Thus, there is a continuing need for an antenna that may be used in a wireless mobile device, which is minimally affected by the noise of the device.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is a schematic diagram of an unbalanced planar inverted F-shaped antenna, according to the prior art;

FIG. 2 is a schematic diagram of a mobile noise mitigation system, according to some embodiments;

FIG. 3 is a schematic diagram of a balanced dipole antenna used in the mobile noise mitigation system of FIG. 2 for wireless internet connection, according to some embodiments;

FIG. 4 is a schematic diagram of a balanced bowtie dipole antenna, used in the mobile noise mitigation system of FIG. 2 for digital television, according to some embodiments;

FIG. 5 is a schematic diagram of a second balanced bowtie dipole antenna connected to a commercially available balun, used in the mobile noise mitigation system of FIG. 2 for digital television, according to some embodiments;

FIG. 6 is a frequency versus noise graph, comparing the unbalanced antenna of FIG. 1 with the balanced dipole antenna of FIG. 3, according to some embodiments;

FIG. 7 is a noise power measurement configuration for testing the DTV antenna of FIG. 3 integrated into the mobile noise mitigation system of FIG. 2, according to some embodiments; and

FIG. 8 is a frequency versus noise graph, comparing the unbalanced antenna of FIG. 1 with the balanced bowtie dipole antenna of FIG. 4, according to some embodiments.

### DETAILED DESCRIPTION

In accordance with the embodiments described herein, a balanced antenna is integrated into a wireless mobile device for noise mitigation. The wireless mobile device may be a laptop computer, as one example. In some embodiments, a balanced dipole antenna is placed inside the laptop computer for wireless internet connection. The antenna is connected to a radio frequency (RF) interconnection cable, such as a coaxial cable. A balun is disposed between the antenna and the cable. In other embodiments, a balanced bowtie dipole antenna is placed inside the laptop computer for digital television support. Again, a balun is used to balance the antenna with the RF interconnection cable. By using a balanced antenna configured as described herein, the fraction of the noise produced by the motherboard and display of the wireless mobile device that is captured by the antenna is significantly reduced compared to that captured by an unbalanced antenna. Further, the surface current of outer conductors of the RF interconnection cable as well as radiation from the ground plane of the wireless mobile device are suppressed, so that the overall noise power is minimized.

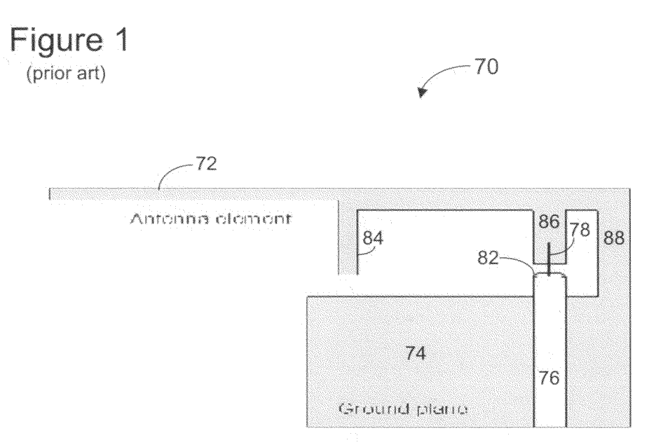

FIG. 1 is a depiction of a prior art planar inverted F-shaped antenna (PIFA) system 70, known also herein as antenna 70. The antenna 70 includes an antenna element 72 and a ground plane 74. The antenna 70 is an example of an unbalanced antenna. The antenna element 72 is F-shaped, with teeth 84, 86, and 88, the last of which is connected to the ground plane 74. The antenna 70 is connected to an unbalanced coaxial cable 76 having an outer conductor 82 and an inner conductor 78, where the coaxial cable 76 is connected to a transmitter, a receiver, or a combination transmitter/receiver (not shown). The outer conductor 82 is connected to the ground plane 74 of the antenna 70 while the inner conductor 78 is connected to the tooth 86 of the antenna element 72.

By connecting the coaxial cable 76 to the antenna 70, the antenna radiates. In addition to the antenna element 72 radiating, as intended, however, the ground plane 74 of the antenna 70, and thus the coaxial cable 76 to which the ground plane is connected, may radiate as well. Where a source of noise is close to the antenna and/or the coaxial cable, the signal-to-noise ratio (SNR) is lowered, resulting in a diminishment of range and throughput by the antenna 70. Where the antenna 70 is used in a wireless device, such as a notebook computer, the antenna 70 and coaxial cable 76 are positioned without consideration of the noise effect from the motherboard (also known as the system board) and the video display. Such positioning is not successful with a wireless mobile device, as the antenna/ground plane/interconnect cables collect noise, resulting in performance degradation.

Because of the sources of noise (most notably, the motherboard and the display), positioning the antenna 70 internally within the wireless mobile device, is thus generally unsuccessful. In addition to the motherboard being a source of noise, display devices such as liquid crystal display (LCD) systems cause noise to be collected by the coaxial cable 76 as well as from the antenna element 72. The noise level of the motherboard and LCD reduces the SNR such that the transmitter, receiver, or transmitter/receiver connected to the antenna 70 is capable of processing only very high-power signals.

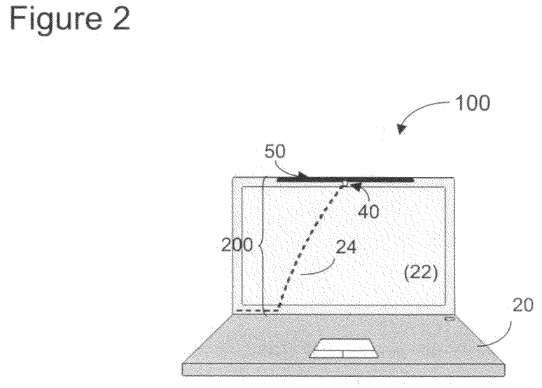

To solve this problem, a balanced antenna may be disposed inside a wireless mobile device, while maintaining a high SNR. FIG. 2 is a schematic diagram of a mobile noise mitigation system 100, according to some embodiments. The mobile noise mitigation system 100 includes a wireless mobile device 20 and an internal antenna system 200. The wireless mobile device 20 appears to be a laptop computer, but may also be one of many types of wireless mobile devices, including, but not limited to, personal digital assistants (PDAs), ultra mobile personal computers (UMPCs), mobile internet devices (MIDs), and cellular telephones.

The wireless mobile device 20 of FIG. 2 includes a display 22, such as a liquid crystal display (LCD). The internal antenna system 200 includes an antenna 50, a radio frequency (RF) interconnection cable 24, and a balun 40. The internal antenna system 200 transmits and receives wireless signals from and to the wireless mobile device 20. Although depicted schematically as being horizontally disposed atop the display 22 of the wireless mobile device 20, the antenna 50 may actually be disposed beneath the housing of the device. The antenna 50 may be positioned above the display 22, below the display, such as between the display and the motherboard (e.g., at the joint between the base of the laptop and the display), on either side of the display, or between the side of the display chassis and an outer plastic covering. Thus, the internal antenna 50 is not visible to the user of the wireless mobile device 20, but is nevertheless operational in this configuration.

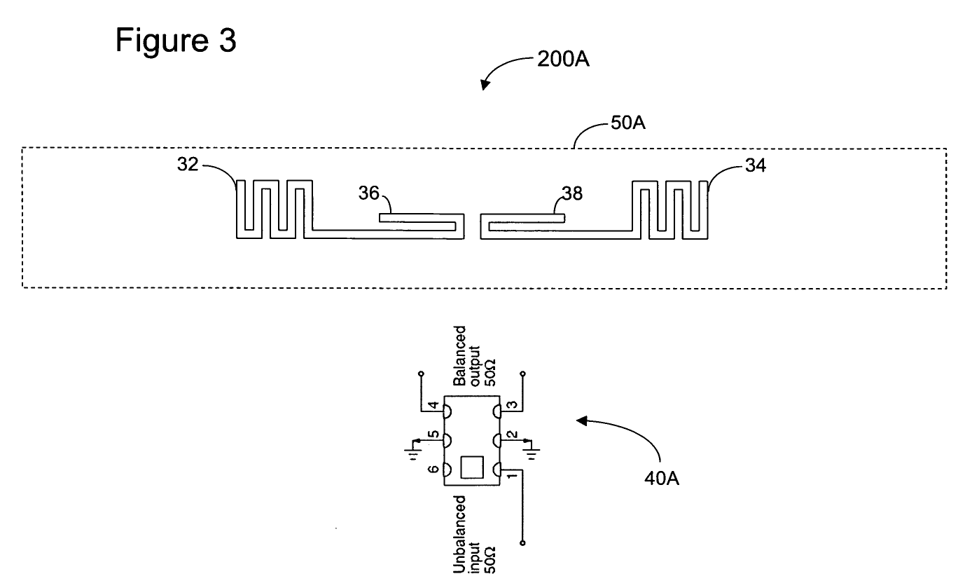

The antenna system 200 is described further in FIGS. 3, 4, and 5, below. Part of the antenna system 200, the RF interconnection cable 24, is disposed behind the display 22 of the wireless device 20. In FIG. 2, dotted lines indicate one possible location of the RF interconnection cable 24 behind the display 22. In some embodiments, the RF interconnection cable 24 is disposed between the back of the display 22 and an enclosure of the wireless device 20, such as a plastic covering. The RF interconnection cable 24 may be any of a variety of cabling, such as a coaxial cable or a twisted pair cable. In some embodiments, the RF interconnection cable 24 is a Hirose coaxial cable.

As explained above, the antenna 70 of FIG. 1 does not radiate successfully in the configuration shown in FIG. 2, due to the decreased SNR caused by the proximity of the antenna element 72 and coaxial cable 76 to the sources of noise in the laptop computer. (While the antenna 70 is capable of receiving the intended signal, the receiver receives a substantially reduced signal, due to the noise, which is insufficient for processing. The effect is that the antenna 70, therefore, does not “work” in the laptop environment.) Two features of the antenna system 200 are distinguishable from that of the antenna 70. First, the antenna 50 in FIG. 2 is a dipole antenna, which has no ground plane. Second, a balun 40 is disposed between the antenna 50 and the RF interconnection cable 24, which keeps the cable from becoming a “third arm” of the dipole antenna and collecting noise from its surrounding environment.

A balun 40 connects the antenna 50 to the RF interconnection cable 24, which is fed into a receiver, a transmitter, or a combination transmitter/receiver (not shown). A balun is a type of transformer that connects a balanced device to an unbalanced device. Hence, the word “balun” is a combination of the words “balanced” and “unbalanced”. A balanced line is one that has two conductors with equal currents in opposite directions. In other words, both conductors have the same voltage with respect to ground. A twisted pair cable is an example of a balanced line. An unbalanced line is one that includes one conductor and ground. A coaxial cable is a type of unbalanced line. The balun may convert an unbalanced signal to a balanced signal, or vice-versa. One of the applications of a balun is to connect a dipole antenna, which is balanced, to an unbalanced coaxial transmission line. The balun divides the signal from the coaxial cable into two equal signals to be transmitted on the two poles of the antenna. The balun also provides one of the two equal signals with a predetermined phase and the other of the equal signals with a 180-degree phase difference relative to the predetermined phase.

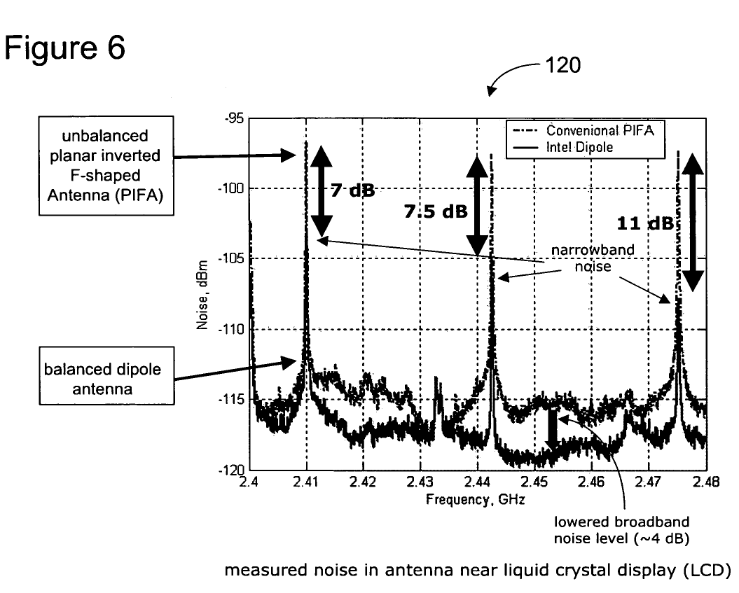

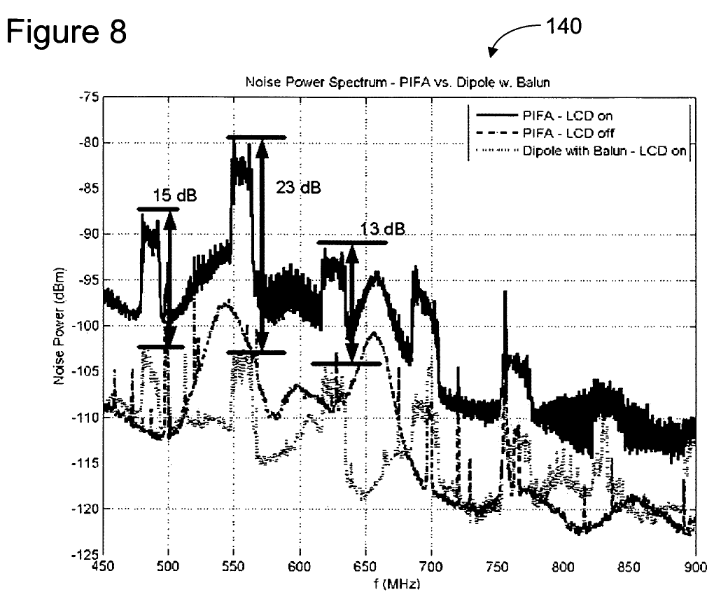

The balun 40 is included with the internal antenna 50 to mitigate noise in the wireless mobile device 20. Experimental results show that the use of a balun with the antenna 50 substantially mitigates noise produced by the display of the wireless mobile device, in some embodiments. FIGS. 6 and 8, described in more detail below, demonstrate the extent of noise mitigation using the antenna system 200 within the wireless noise mitigation system 100.

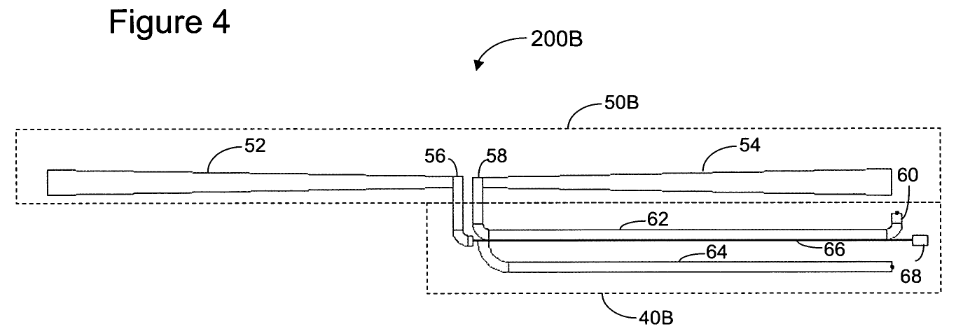

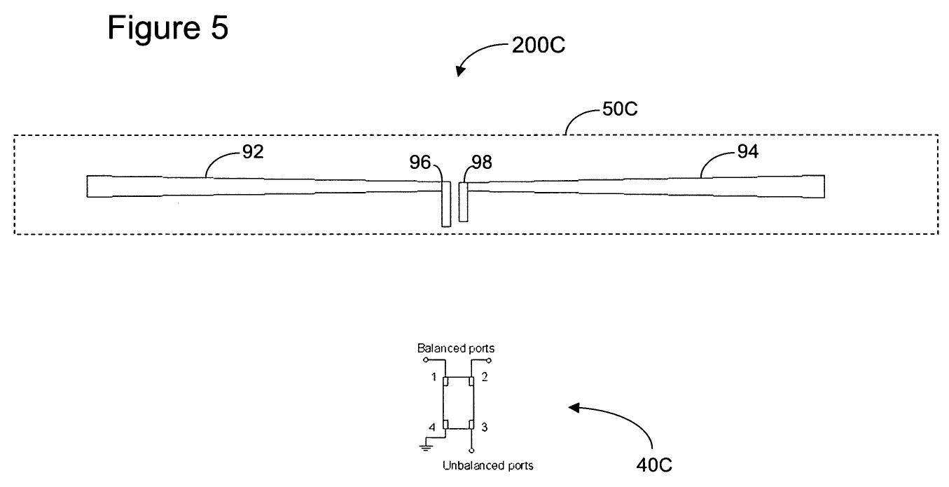

In some embodiments, the wireless noise mitigation system 100 of FIG. 2 utilizes different antennas 50 for different applications, in which the antennas are optimally selected according to the frequency range of the respective application. For example, in some embodiments, the wireless noise mitigation system 100 employs a balanced dipole antenna 50A (FIG. 3) for wireless internet connections and a balanced bowtie dipole antenna 50B (FIG. 4) or 50C (FIG. 5) for digital television (DTV) applications. (The antennas 50A, 50B, and 50C are collectively referred to herein as antennas 50; likewise, the baluns 40A, 40B, and 40C are collectively referred to herein as baluns 40). The different antennas are optimally selected to operate at different frequencies. Wireless internet connections operate at a range between 2.4 and 2.48 GHz while digital televisions operate at between 470 and 862 MHz. Standard ultra-high frequency (UHF) television signals operate in a range of 450-900 MHz. By simply adjusting the characteristics of the antenna 50 of the antenna system 200, the wireless noise mitigation system 100 may thus be operable for a variety of frequency ranges. Antenna designers of ordinary skill in the art understand how adjustment of the arm lengths of the antenna relative to the wavelength of the intended signal may be achieved.

FIG. 3 is a schematic diagram of a balanced dipole antenna system 200A to be used in the wireless noise mitigation system 100 for wireless internet connections, according to some embodiments. The antenna system 200A includes a balanced dipole antenna 50A, a balun 40A, and an RF interconnection cable (not shown). The balanced dipole antenna 50A includes a left arm 32 and a right arm 34, for receiving a radio frequency (RF) signal from the air or for transmitting the RF signal to the air. Extending from the arms 32, 34 are connectors 36, 38, respectively, for connection to the balun 40A.

The balun 40A includes an unbalanced input (1) to be connected to the RF interconnection cable (not shown), and two balanced output signals (3, 4) to be connected to the connectors 36, 38 of the antenna 50A. The signals received from the connectors 36, 38 are identical. The dipole antenna 50A does not have a ground plane. Table 1 shows the terminal functions of the balun 40A.

TABLE 1
Terminal functions for balun 40A.

| terminal | function |
|---|---|
| 1 | unbalanced port |
| 2 | ground or DC feed + RF ground |
| 3 | balanced port |
| 4 | balanced port |
| 5 | ground |
| 6 | no connection |

FIG. 4 is a schematic diagram of balanced bowtie dipole antenna system 200B to be used in the wireless noise mitigation system 100 for digital television (DTV) applications, according to some embodiments. The antenna system 200B includes a balanced bowtie dipole antenna 50B, a balun 40B, and an RF interconnection cable (not shown). The balanced bowtie dipole antenna 50B includes a left arm 52 and a right arm 54, for receiving a radio frequency (RF) signal from the air or for transmitting the RF signal to the air. Extending from the antenna arms 62, 64 are microwave strip lines 56, 58, respectively, for connection to the balun 40B.

The balun 40B includes asymmetric microstrip coupled lines 62 and 66 with quarter-wavelength single stub 64, both of which extend from microstrip line 56 to the left antenna arm 52 and microstrip line 58 to the right antenna arm 54, respectively. The upper asymmetric microstrip coupled line 62 has a connection of microstrip line with via hole 60 at its distal end, which connects the balun circuit to ground. The lower asymmetric microstrip coupled line 66 with an unbalanced input port 68 has a connection of a quarter wavelength single stub with a via hole 64, which connects the ground plane of the balun circuit, both of which extend from the microstrip line 56 and the antenna left arm 52. Signals received from both of the antenna arms 52, 54 to the extended microstrip lines 56, 58, respectively, are identical. Referring to the receive operation of the antenna 50B, the signals received from the antenna arms 52, 54 have the same magnitude, with 180 degrees out-of-phase in the presence of the balun 40B.

When the antenna 50B is part of the mobile noise mitigation system 100 (FIG. 2), the unbalanced RF interconnection cable 24 is to be coupled to the unbalanced input port 68. The bowtie dipole antenna 50B does not have a ground plane. In some embodiments, the balun 40B is manufactured on the same surface as the antenna 50B. By manufacturing the antenna 50B and the balun 40B together, substantial cost savings may be realized over attaching an over-the-counter balun (see, e.g., FIG. 5, below).

Alternatively, the mobile noise mitigation system 100 may employ an antenna system 200C, according to some embodiments, as depicted in FIG. 5. The antenna system 200C includes a dipole antenna 50C, an off-the-shelf balun 40C, and the RF interconnection cable (not shown). The dipole antenna 50C may be used with the balun 40C, such as when internal space for both the antenna and the microstrip line balun 40B in FIG. 4 are not available. The dipole antenna 50C is preferred for DTV applications, in some embodiments, and the balun 40C is commercially available. In the wireless noise mitigation system 100 (FIG. 2), the balanced ports 1, 2 of the balun 40C are each connected to one of the connectors 96, 98 of the antenna 50C. The unbalanced port 3 of the balun 40C is connected to the inner conductor of the RF interconnection cable 24 while the ground port 4 of the balun is connected to the outer conductor of the cable 24.

Empirical measurements of the antenna system 200 as part of the wireless noise mitigation system 100 show striking improvement in noise mitigation using the dipole antennas 50 (FIGS. 3, 4, and 5) with their respective baluns 40. In FIG. 6, for example, the performance of the unbalanced commercially available PIFA (not shown) is contrasted with the balanced dipole antenna 50A (FIG. 3) in the mobile noise mitigation system 100 (FIG. 2). A graph 120 plots frequency (GHz) versus noise (dBm) for the measured noise in each antenna, where the antenna is operating in a mobile noise mitigation system 100 and the measurement is taken from the antenna integrated near the LCD display 22. The noise is measured in the frequency of 2.4˜2.48 Gigahertz (GHz), as represented by the X-axis. (This is the frequency range for wireless internet connections.) The Y-axis is the measured noise level in decibels (referenced to milliWatts), or dBm. A lower noise level is preferred.

A ceramic balun interface is used to provide 180 degrees out-of-phase in the balanced dipole antenna 50A. Each antenna 50A and 70 is fed with single hirose coaxial cable as the RF interconnection cable 24.

Before generating the graph 120, the noise of the wireless mobile device 20 is measured with the antennas 50A and 70 positioned in a number of different locations, with one of the samples resulting in the graph 120. The graph 120 shows that the balanced antenna 50A lowers noise over the whole frequency range, with a maximum difference of four decibels (4 dB). In addition to the broadband noise reduction, the narrowband noise of the balanced antenna 50A, as indicated by the arrows, is decreased by up to 11 dB over the conventional antenna 70.

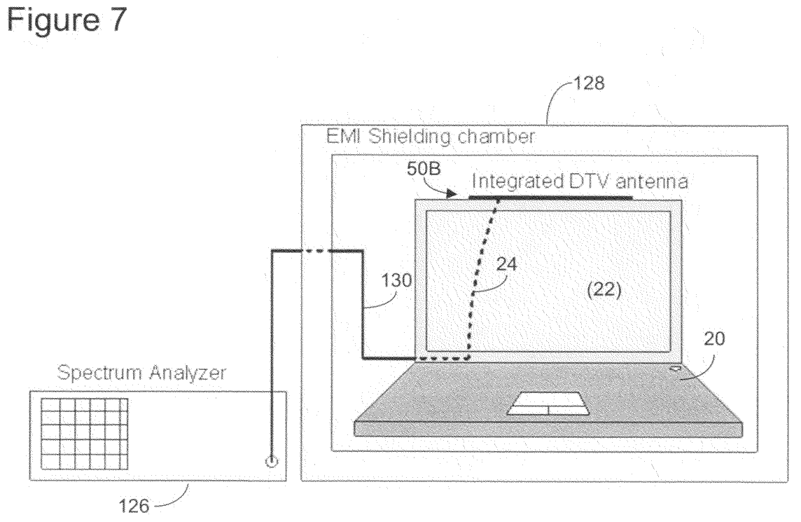

FIG. 7 show a noise measurement setup of the balanced antenna 50C (FIG. 5) disposed in the mobile noise mitigation system 100 of FIG. 2, according to some embodiments. The RF interconnection cable 24 is a single hirose cable, coupled between the antenna 50C and a radio module. (Although not shown, the radio module is also internal to the laptop computer 20). A chamber 128 surrounds the laptop computer 20, shielding the antenna 50C, the cable 24, and the laptop computer 20 from electromagnetic interference (EMI). The hirose cable 24 is connected to an external coaxial cable 130 as shown. Platform noise is measured in the EMI shielding box 128 and is recorded in the spectrum analyzer 126.

FIG. 8 is a graph 140 showing the measured noise power for two different antennas over an ultra-high frequency (UHF) of 450 to 900 MHz, using the configuration of FIG. 7. The graph 140 plots frequency (MHz) in the X-axis versus dBm in the Y-axis, which normalizes to milliwatts (0 dBm→1 mW). A lower amount of noise power may be interpreted as a favorable radio operating condition, relative to a higher amount of noise power. The laptop 20 is turned on with Windows XP running during the measurements. (Windows XP is a product of Microsoft Corporation of Redmond, Wash.) The solid black plot represents the noise spectrum received from an integrated PIFA, such as the antenna 70 of FIG. 1. The middle darkly dotted plot is the measured noise spectrum from the antenna 70 when power to the LCD display 22 is turned off (but the laptop 20 is still on). There is a significant difference in the noise level when the LCD display 22 is turned on, which demonstrates the critical noise emission from LCD circuits.

The lower lightly dotted plot shows the noise power measured with the dipole antenna 50C with an over-the-counter balun as a balanced feeding when the LCD display 22 is turned on. Broadband noise is now decreased by more than 10 dB over the whole frequency band of interest and more than 20 dB improvement in narrowband interferences.

The measured data is correlated with the measured data in 2.4˜2.48 GHz, as shown in FIG. 8. The graph 140 demonstrates that the balanced dipole antenna 50C is mitigates noise in a wireless mobile device and may be extended to any frequency bands. The cost of the balanced dipole antennas 50A, 50B, and 50C are comparable to the cost of the conventional PIFA antenna 70. In contrast to the antenna 70, however, the balanced dipole antennas 50 provide internal integration with low noise in the wireless mobile device.

The antenna system 200 with the balanced dipole antenna 50 may be a useful low-cost solution for mitigating the platform noise to improve the wireless performance with minimum modification of the wireless mobile device. The antenna system 200 may be attractive in laptop and other mobile internet device (MID) platforms. Original equipment manufacturers (OEMs) may show interest in this technology.

By simply replacing the unbalanced antenna 70 (FIG. 1) with the balanced antenna 50A (FIG. 3), 50B (FIG. 4) or 50C (FIG. 5) in the laptop computer 20, significant improvement in noise mitigation is demonstrated, according to some embodiments. For example, measurements in the frequency of 2.4 GHz for WiFi/WiMAX and in the frequency of 470˜862 MHz for DTV applications show such improvement.

In some embodiments, the antenna system 200 increases the data throughput and range of the wireless communication significantly by decreasing the magnitude of platform noise at the antenna port of the wireless device. General approaches to mitigate the noise include the use of shielding, use of an adaptive clock, and reduction in the noise level of the platform of the mobile device. Use of the balanced dipole antenna 50 is cheaper and less complex than these alternative approaches.

In some embodiments, the antenna system 200 enables an internal digital TV antenna installation in the laptop computer with a good signal-to-noise ratio (SNR), providing good TV signal comparable or better than is obtainable using an external antenna configuration. Currently, external antennas are used for DTV reception in laptop computers because of a high level of platform noise obtained by conventional unbalanced antennas. An external DTV antenna increases the cost and complexity of the laptop computer, which computer OEMs prefer to avoid. A noise mitigated embedded DTV antenna may be preferred by OEMs and wireless companies, due to the use of an internal antenna with low noise in the laptop configuration.

The antenna system 200 increases the operational coverage area, such as DTV, wireless local area network (WLAN), and so on, by reducing the noise sensitivity of the receiver. An empirical study using the balanced dipole antenna 50 with DTV produces a signal strength of 90 dB uV/m at the rooftop level (10 m above ground), while the unbalanced internal antenna 70 picks up 15 dB of platform noise. This result explains why receiving a satisfactory signal at a given location in a cell (i.e., coverage probability) is likely to diminish from 100% to less than 50% when using the unbalanced internal antenna. Reducing the noise pickup at the antenna by 12 dB (i.e., 3 dB receiver noise sensitivity) using the balanced dipole antenna 50 improves the coverage probability to 90%, in some embodiments. Hence, controlling noise pickup has a direct and beneficial impact on the link budget in fixed transmit power (broadcast systems). This allows for extended coverage (less than 50% to more than 90% coverage probability).

Combined with diversity, the empirical results indicate a possibility of obtaining performance akin to a single external antenna with the use of the internal antenna solution. The internal (embedded) dipole antenna 50 may be used for DTV, UHF, wireless internet, and other wireless technologies in the mobile platform. In contrast to the current paradigm, which uses only external antennas with wireless mobile devices, an embedded internal antenna may significantly increase user convenience while still allowing for an attractive industrial design. The capability of integrating digital TV antennas in the mobile platform chassis may be a significant differentiator for a laptop computer OEM.

While the application has been described with respect to a limited number of embodiments, those skilled in the art will appreciate numerous modifications and variations therefrom. It is intended that the appended claims cover all such modifications and variations as fall within the true spirit and scope of the above description.

We claim:

1. A system, comprising:
a wireless mobile device comprising a motherboard and a display;
a balanced dipole antenna located inside the wireless mobile device, the balanced dipole antenna being coupled to an unbalanced cable, the cable to connect to the antenna to a receiver, a transmitter, or a transmitter/receiver disposed within the wireless mobile device, wherein the antenna is enclosed within the wireless mobile device; and
a balun coupled between the antenna and the cable.

2. The system of claim 1, wherein the balanced dipole antenna is a balanced bowtie dipole antenna.

3. The system of claim 2, wherein the antenna is capable of successfully receiving digital television signals at frequencies between 470 and 862 megahertz.

4. The system of claim 1, wherein the antenna is capable of successfully receiving wireless internet signals at frequencies between 2.4 and 2.48 gigahertz.

5. The system of claim 1, wherein the antenna is capable of successfully receiving ultra-high frequency television signals at frequencies between 450 and 900 megahertz.

6. The system of claim 1, wherein the unbalanced cable is a radio frequency interconnection cable.

7. The system of claim 6, wherein the radio frequency interconnection cable is a hirose coaxial cable.

8. The system of claim 1, wherein the display is a liquid crystal display.

9. The system of claim 1, wherein the wireless mobile device is a laptop computer.

10. The system of claim 1, wherein the unbalanced cable is disposed behind the display, between the display and an enclosure of the wireless mobile device.

11. An antenna system for internal use within a wireless mobile device having a display, the antenna system comprising:
a balanced dipole antenna comprising a left arm and a right arm, wherein the left arm and the right arm are symmetrical;
an unbalanced cable to couple the balanced dipole antenna to a receiver, a transmitter, or a transmitter/receiver;
a balun coupled between the balanced dipole antenna and the unbalanced cable;
wherein the balanced dipole antenna, the unbalanced cable, and the balun are located inside the wireless mobile device.

12. The antenna system of claim 11, the balun further comprising:
a first arm coupled to the left arm of the antenna;
a second arm coupled to the first arm; and
a rod;
wherein the first arm and the rod are coupled to the unbalanced cable.

13. The antenna system of claim 11, wherein the unbalanced cable is a radio frequency interconnection cable.

14. The antenna system of claim 13, wherein the radio frequency interconnection cable is a hirose coaxial cable.

15. The antenna system of claim 11, wherein the balanced dipole antenna and the balun are simultaneously manufactured using similar materials.

16. The antenna system of claim 11, wherein the balun is an off-the-shelf part.

17. The antenna system of claim 11, wherein the balanced dipole antenna is a balanced bowtie dipole antenna

18. A wireless mobile device, comprising:
a liquid crystal display;
a balanced dipole antenna comprising two symmetrical arms; and
a balun coupled between the balanced dipole antenna and a cable, the cable being disposed behind the liquid crystal display and between the liquid crystal display and an enclosure of the wireless mobile device;
wherein the cable couples the antenna to a receiver, a transmitter, or a transmitter/receiver.

19. The wireless mobile device of claim 18, wherein the cable is an unbalanced hirose coaxial cable.

20. The wireless mobile device of claim 19, wherein the receiver successfully receives digital television signals.
